(19) United States
(12) Patent Application Publication
(10) Pub. No.: US 2025/0313468 A1
(43) Pub. Date: Oct. 9, 2025

(54) TAIL GAS TREATMENT SYSTEM AND METHOD FOR A SULFURIC ACID PRODUCTION PLANT

(71) Applicant: CHEMETICS INC., Vancouver (CA)

(72) Inventor: Rene DIJKSTRA, Vancouver (CA)

(21) Appl. No.: 18/869,762

(22) PCT Filed: May 17, 2023
(86) PCT No.: PCT/CA2023/050677

§ 371 Date: Nov. 26, 2024

Related U.S. Application Data
(60) Provisional application No. 63/346,579, filed on May 27, 2022.

(51) Int. Cl. C01B 17/80; B01D 53/50

(52) U.S. Cl. CPC C01B 17/80; B01D 53/507; B01D 2251/102; B01D 2251/506; B01D 2253/102; B01D 2257/302

(57) ABSTRACT

Improved systems and methods are disclosed for treating tail gas in a sulfuric acid production plant. A tail gas treatment system is employed which comprises a product stripper and a purge gas scrubber. The inventive arrangement provides an advantageous economical way to remove high levels of SO₂ from the tail gas stream.

### TECHNICAL FIELD

The present invention pertains to improved tail gas treatment systems and methods of operation for use in sulfuric acid production plants.

### BACKGROUND

Sulfur dioxide is a commonly produced industrial chemical for use as a reactant in various other chemical processes. It is produced in both pure SO₂ gas and/or liquefied SO₂ form for sale and as a gas mixture for use in downstream processes. A major industrial application for sulfur dioxide is in the production of sulfuric acid which is one of the most produced commodity chemicals in the world and is widely used in the chemical industry and commercial products.

Nowadays, the contact process is the primary process used to produce sulfuric acid commercially (developed in 1831 by P. Phillips). Typically, this involves obtaining a supply of sulfur dioxide by combusting a supply of sulfur with ambient air and then oxidizing the sulfur dioxide with oxygen in the presence of a catalyst (typically vanadium oxide) to accelerate the reaction in order to produce sulfur trioxide. The reaction of sulfur dioxide to sulfur trioxide is reversible and exothermic and it is important to appropriately control the temperature of the gases over the catalyst in order to achieve the desired conversion without damaging the catalyst and/or the contact apparatus which comprises the catalyst.

The produced sulfur trioxide is then converted to sulfuric acid by absorption into a concentrated sulfuric acid solution with subsequent water addition to the now more concentrated acid to maintain the acid concentration. This indirect reaction of the sulfur trioxide with water avoids the consequences of directly dissolving sulfur trioxide into water which is a highly exothermic reaction. The absorbing of the sulfur trioxide is usually done in one or more absorption towers.

Distributors are used in the absorption towers to distribute strong sulfuric acid solution across the top of a packed bed within the tower. Sulfur trioxide gas flows through the tower in generally counter-current flow to the solution, but it can also flow cocurrently. The strong sulfuric acid solution is used to absorb the flowing sulfur trioxide.

In WO2008/052649, a process was disclosed for the continuous catalytic complete or partial oxidation of a starting gas containing from 0.1 to 66% by volume of sulfur dioxide plus oxygen, in which the catalyst is kept active by means of pseudo-isothermal process conditions with introduction or removal of energy. The related apparatus is for the continuous catalytic complete or partial oxidation of a starting gas containing sulfur dioxide and oxygen, and is characterized by at least one tube contact apparatus which is an upright heat exchanger composed of at least one double-walled tube whose catalyst-filled inner tube forms a reaction tube, with heat being transferred cocurrently around the reaction tube and an absorber for separating off SO₃ being installed downstream of the tube contact apparatus. The reactivity of the catalyst is preset by mixing with inert material. This process and apparatus are commercially available under the trade-marks CORE™ and CORE-S™.

Historically, commercial sulfur burning, sulfuric acid plants have used ambient air as the source of the oxygen required in the process. The use of ambient air is inexpensive and the conventional process operating at approximately 11-12 vol % SO₂ into the contact apparatus perfectly balances the O₂:SO₂ ratio required for high conversion and the maximum allowable temperature in the first catalyst bed. The disadvantage of using air is that each required molecule of oxygen also comes with approximately four molecules of inert gas (mainly N2 and argon) which must also flow through the plant, therefore requiring very large equipment to handle the entire gas flow. To improve efficiencies and reduce emissions, commercial sulfuric acid plants using ambient air are often of the double contact, double absorption (DCDA) design. In a DCDA system, process gases are subjected to two contact and absorption stages in series. (i.e. a first catalytic conversion and subsequent absorption step followed by a second catalytic conversion and absorption step). Sulfur dioxide for the system can be produced by combusting sulfur with ambient air in a single reactor after which the reactor gases produced are cooled in a heat exchanger prior to being supplied to the contact apparatus. A large portion of the incoming air is discharged to the stack because of the high proportion of inert gases present in the incoming ambient air. The result is that even low concentrations of SO₂ present in the tail gas discharged to the stack result in significant emissions when evaluated on a mass flow (kg/hr) basis. Details regarding the conventional options available and preferences for sulfuric acid production and the contact process are well known and can be found for instance in “Handbook of Sulfuric Acid Manufacturing”, Douglas Louie, ISBN 0-9738992-0-4, 2005, published by DKL Engineering, Inc., Ontario, Canada.

The use of highly enriched or pure oxygen to-date has also been hindered by the cost of providing such oxygen and plants would have to offset the cost of oxygen against cost savings in the process. New and emerging technologies are now becoming available where oxygen or high purity oxygen is a by-product from the process (e.g., water hydrolysis to produce green hydrogen) and this can provide lower cost sources of highly enriched or pure oxygen with the potential for economic integration of various processes. One such example is described in published PCT application WO2021/118599 (application number PCT/US2019/066262).

Recently sulfuric acid plants and processes have been proposed in which sulfur combustion is carried out using pure oxygen and a submerged combustion process. In this process, highly enriched or pure oxygen is injected into a bath of molten sulfur. Energy released as the oxygen reacts with sulfur is used to evaporate sulfur from the bath. The sulfur evaporated is condensed in a downstream condenser to recover the energy and the condensed sulfur is returned to the bath. The advantage of submerged combustion is that the temperature of the combustion products are limited to the boiling point of sulfur which is ˜450° C. at pressure of 0.5 barg. This technology is disclosed in detail in Canadian patent application CA3021202 titled Sulfuric Acid Plant and published Dec. 24, 2018. The design offers lower capital expenditure as well as enhanced energy recovery and allows for practical production capacities in excess of 10,000 mtpd. The submerged combustion does not require a large gas recycle in order to control temperature and minimal NOx formation is involved due to the low operating temperature. However, submerged combustion system is relatively complex since it involves containment of sulfur vapor at high temperature and thus material concerns.

In Canadian patent application 3,141,027 which published Feb. 15, 2022, improved systems and methods were disclosed for producing sulfuric acid or for producing liquefied sulfur dioxide. The systems comprise a reactor for the combustion of sulfur to sulfur dioxide, a reactor gases heat exchanger, and either a contact apparatus and absorption apparatus combination or an absorption subsystem and liquefaction apparatus combination for producing either sulfuric acid or liquid sulfur dioxide respectively. By appropriately incorporating two recycle circuits, the first after the reactor gases heat exchanger and the second after the absorption apparatus or liquefaction apparatus, several advantages can be obtained. These include reductions in equipment size, complexity, power consumption energy losses, and suppression of NOx formation.

In EP1654052 and U.S. Pat. No. 5,019,361, a process is described for the removal of SO₂ from a gas stream using an aqueous absorbing medium containing a water-soluble amine and the subsequent regeneration of the used absorbent using low pressure steam. The disadvantage of this method is the high steam consumption in the regeneration system as well as the need to remove impurities from the absorbent which results in the formation of an effluent stream that must be treated.

Numerous processes exist (e.g. as described in EP0238811) for the removal of SO₂ from gas streams by absorption of the SO₂ in aqueous solutions containing a reagent (e.g. sodium hydroxide, calcium hydroxide, ammonia or hydrogen peroxide) which reacts with SO₂ to form a stable component with a low SO₂ vapor pressure. The disadvantage of these methods is that the reagent use is directly related to the amount of SO₂ that needs to be removed from the gas and in many cases an aqueous or solid effluent is created that must be further treated.

In processes that utilize pure oxygen in the production of sulfuric acid, a small portion of gas must be removed (purged) continuously from the process because otherwise inert gases (mainly argon and nitrogen) entering the process with the pure oxygen stream build up to unacceptable levels. Hence there remains a desire for continual improvement in plant design to reduce undesirable components (e.g. SO₂) from this purge gas stream before it is emitted to atmosphere. The present invention addresses this desire and provides other benefits as disclosed below.

### SUMMARY

Improved systems and related methods are disclosed for treating tail gas in a sulfuric acid plant. Specifically, a tail gas treatment system of the invention is for a sulfuric acid production plant comprising a supply of pure oxygen, a combustion reactor for the combustion of sulfur to sulfur dioxide using oxygen from the supply of pure oxygen, a reactor gases heat exchanger fluidly connected to the combustion reactor for cooling combustion reactor outlet gases, a contact apparatus fluidly connected to the reactor gas heat exchanger for the conversion of sulfur dioxide to sulfur trioxide, an absorption apparatus fluidly connected to the contact apparatus for absorbing sulfur trioxide into sulfuric acid to form concentrated sulfuric acid, the tail gas treatment system, and an exhaust stack fluidly connected to the tail gas treatment system in which the absorption apparatus comprises an outlet fluidly connected to both the combustion reactor and to the tail gas treatment system. The tail gas treatment system comprises:
a product stripper comprising:
   a stripping column;
   a liquid inlet for concentrated (i.e. >93%) sulfuric acid comprising dissolved sulfur dioxide from the absorption apparatus;
   a stripping gas inlet for an oxygen containing stripping gas;
   an outlet for sulfuric acid partially stripped of sulfur dioxide; and
   an outlet for stripping gas comprising the sulfur dioxide partially stripped from the sulfuric acid;
and
a purge gas scrubber comprising:
   an absorber column;
   an inlet for the sulfuric acid partially stripped of sulfur dioxide from the product stripper;
   a purge gas inlet for purge gas obtained from the gas outlet of the absorption apparatus;
   an outlet for sulfuric acid comprising dissolved sulfur dioxide from the purge gas;
   an outlet for purge gas comprising purge gas partially stripped of sulfur dioxide.

In the tail gas treatment system, the oxygen containing stripper gas can be pure oxygen from the supply of pure oxygen. Further, the tail gas treatment system can comprise a heat exchanger for cooling the sulfuric acid partially stripped of sulfur dioxide from the product stripper.

In the tail gas treatment system, the outlet for sulfuric acid from the purge gas scrubber can be fluidly connected to a sulfuric acid inlet in the absorption apparatus. Alternatively, the outlet for sulfuric acid from the purge gas scrubber can be fluidly connected to the liquid inlet of the product stripper. Further, the outlet for stripping gas from the product stripper can be fluidly connected to the combustion reactor or to the contact apparatus. Further still, the tail gas treatment system can comprise a liquid ring compressor for increasing the operating pressure of the purge gas scrubber.

In certain embodiments, the operating pressure of the purge gas scrubber may be greater than the operating pressure of the product stripper.

In certain embodiments, the tail gas treatment system may desirably additionally comprise a tail gas reactor comprising activated carbon, catalyst or absorbent for removing additional sulfur dioxide from the purge gas obtained from the purge gas outlet of the purge gas scrubber.

The invention also includes a sulfuric acid production plant comprising the aforementioned inventive tail gas treatment system. Such a sulfuric acid production plant comprises a supply of pure oxygen, a combustion reactor for the combustion of sulfur to sulfur dioxide using oxygen from the supply of pure oxygen, a reactor gases heat exchanger fluidly connected to the combustion reactor for cooling combustion reactor outlet gases, a contact apparatus fluidly connected to the reactor gas heat exchanger for the conversion of sulfur dioxide to sulfur trioxide, an absorption apparatus fluidly connected to the contact apparatus for absorbing sulfur trioxide into sulfuric acid to form concentrated sulfuric acid, the aforementioned tail gas treatment system, and an exhaust stack fluidly connected to the tail gas treatment system, in which the absorption apparatus comprises an outlet fluidly connected to both the combustion reactor and to the tail gas treatment system

Related methods of the invention are for removing sulfur dioxide from purge gas in the sulfuric acid production plants described above. Specifically, the inventive method comprises:
employing the tail gas treatment system described above as the tail gas treatment system in the plant.
obtaining purge gas from the gas outlet of the absorption apparatus, and
removing sulfur dioxide from the purge gas in the purge gas scrubber using sulfuric acid partially stripped of sulfur dioxide obtained from the product stripper;
   in which the sulfur dioxide concentration in the purge gas obtained from the gas outlet of the absorption apparatus is greater than at least 5% by volume.

In certain embodiments, the sulfur dioxide concentration in the purge gas obtained from the gas outlet of the absorption apparatus can be greater than or equal to 10% by volume. For instance, in an exemplary embodiment the sulfur dioxide concentration in the purge gas obtained from the gas outlet of the absorption apparatus is about 20% by volume.

### BRIEF DESCRIPTION OF THE DRAWINGS

FIG. 1 is a schematic of a sulfuric acid plant comprising a tail gas treatment system of the invention.

FIG. 2 is a schematic showing greater detail of the various elements and their interconnection in the tail gas treatment system of FIG. 1.

FIG. 3 is a schematic showing greater detail of the tail gas reactor in the tail gas treatment system of FIG. 1.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

The term “pure oxygen” is to be considered as meaning oxygen in concentrations equal to or exceeding 90% by volume.

Herein “concentrated sulfuric acid” refers to sulfuric acid with a concentration exceeding 93% by weight.

The term “tail gas” refers to all or a portion of the gas leaving the absorption apparatus in a sulfuric acid plant that is discharged to atmosphere via a stack.

The term “purge gas” refers to the portion of the gas leaving the absorption apparatus that must be removed from the gas recycle stream in a sulfuric acid plant using pure oxygen to maintain a constant inert gas concentration in the process.

The term “inert gas” refers to gases other than O₂, SO₂ and SO₃ that may be present in the gas streams in a sulfuric acid plant

The trade-mark CORE-S™ refers to the molten salt cooled tubular reactor of the technology disclosed in the aforementioned WO2008/052649.

The CORE-SO₂™ process for production of sulfuric acid from sulfur and pure oxygen requires a small amount of purge gas to continuously remove the inert gas contained in the incoming pure oxygen from the recirculating gas. This gas stream is very small compared to the tail gas emitted to the stack in a DCDA plant and contains much higher concentrations (>5 vol %) of residual SO₂ that must be removed before the gas can be safely discharged to atmosphere.

In the present invention, sulfur dioxide gas in the purge gas stream is absorbed into concentrated sulfuric acid. Ordinarily, concentrated sulfuric acid would not be considered as a suitable absorbent for SO₂ removal from a tail gas stream due to the low solubility of SO₂ in concentrated sulfuric acid. This low solubility limits the practical removal of SO₂ from a gas stream to about 400 ppmv. Thus, sulfuric acid cannot be used in a tail gas treatment system for the gas from a conventional DCDA process as the gas leaving the secondary absorption system is already well below this value.

However, in the CORE-SO₂ process, the purge gas that must be treated is both small in volume and contains high (>5 vol %) concentrations of SO₂ and thus the purge gas scrubber can be designed to achieve high removal rates despite the use of a liquid with low SO₂ solubility. Advantageously, the CORE-SO2 process already contains a product stripper where dissolved sulfur dioxide is removed from the concentrated sulfuric acid product. Thus, the purge gas scrubbing can be accomplished with minimal additional equipment and use of a liquid stream already present in the process.

In a preferred embodiment, the purge gas can be compressed to 1-10 barg to enhance the absorption of the sulfur dioxide into the sulfuric acid. The dissolved sulfur dioxide is recovered by returning the sulfur dioxide rich acid to the absorber apparatus (e.g. tower) or the product stripper in the plant, although the former is preferred.

In a further embodiment, the entire sulfuric acid production process can be carried out at elevated pressure. Operation at elevated pressure (e.g. between 1-10 barg) can be economically achieved for the CORE-SO2 process because the pure oxygen can be relatively easily supplied at elevated pressure and there is no need to recover the very small amount of energy contained in the small purge gas stream. It should be obvious to those skilled in the art that this not only reduces the equipment size in the CORE-SO2 process, but also eliminates the need for a purge gas compressor upstream of the purge gas scrubber.

Advantages of the present invention include: minimal additional equipment is required, absorbent already present in the process (i.e. sulfuric acid) is used, and only a small amount of extra energy is required (e.g. to operate a pump and compressor) as regeneration of the absorbent is also accomplished in equipment already present in the process.

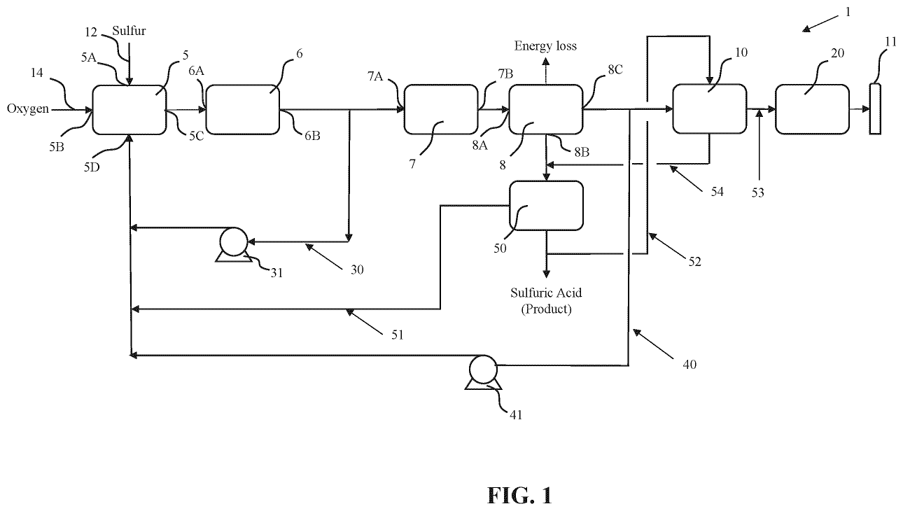

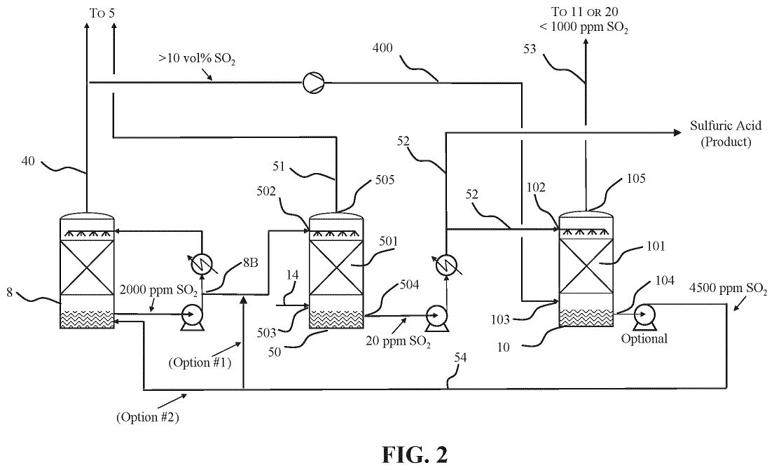

An exemplary embodiment of the tail gas treatment system of the invention is shown in FIGS. 1 though 3. FIG. 1 shows a schematic of a complete sulfuric acid plant comprising a tail gas treatment system of the invention. (Specifically, the plant in FIG. 1 is similar to that shown in FIG. 2a of the aforementioned CA3141027 but with the tail gas treatment system of the present invention incorporated therein.)

FIG. 1 shows a schematic of a portion the sulfuric acid production plant which uses pure oxygen (>90%) in the sulfur combustion. Here, sulfuric acid production plant 1 comprises combustion reactor 5 for combusting sulfur to sulfur dioxide, reactor gases heat exchanger 6 for cooling outlet gases from combustion reactor 5, contact apparatus 7 for converting SO₂ to SO₃, and absorption apparatus 8 for absorbing SO₃ into a supply of sulfuric acid at lower concentration. Downstream of absorption apparatus 8 is purge gas scrubber 10 and tail gas reactor 20 followed by stack 11 for exhausting gases from the system. Product stripper 50 also appears in system 1 as shown. In this embodiment, the tail gas treatment system comprises product stripper 50, purge gas scrubber 10, and tail gas reactor 20 which are interconnected to the rest of plant 1 as shown

In sulfuric acid production plant 1, sulfur 12 and pure oxygen 14 (e.g. 99.5%) are supplied to combustion reactor 5 at inlets 5A and 5B respectively and are reacted together to form SO₂. Reactor outlet gases containing this SO₂ are obtained from combustion reactor 5 at outlet 5C and are directed to inlet 6A of reactor gases heat exchanger 6 in which these gases are cooled. The cooled reactor gases are then directed from reactor gases heat exchanger outlet 6B to contact apparatus 7 at inlet 7A. In contact apparatus 7, SO₂ in the cooled reactor gases is converted to SO₃ after which the gases from contact apparatus 7 are directed from outlet 7B to absorption apparatus 8 (shown as a tower in FIG. 2) at inlet 8A. In absorption apparatus 8, SO₃ is absorbed into a weaker sulfuric acid solution to produce the desired, higher concentration sulfuric acid product. This higher concentration sulfuric acid is removed at outlet 8B and the remaining unabsorbed gases from the contact apparatus are removed at outlet 8C and then directed to purge gas scrubber 10.

Also shown in FIG. 1 and as discussed in detail in the aforementioned CA3141027, gases from both first recycle circuit 30 and second recycle circuit 40 are used to dilute and cool combustion gases in combustion reactor 5. First recycle circuit 30 fluidly connects outlet 6B of reactor gases heat exchanger 6 to recycle inlet 5D of reactor 5 and thus recycles a portion of the cooled reactor gases from reactor gases heat exchanger 6, while second recycle circuit 40 also fluidly connects absorption apparatus outlet 8C to recycle inlet 5D of reactor combustion 5 and thus recycles a portion of the unabsorbed contact apparatus gases from absorption apparatus 8. The two recycle circuits comprise pumps 31 and 41 respectively and in principle any type of pump may be considered for such use. including blowers, fans or ejectors. However, due to the larger pressure difference that pump 41 must deal with in second recycle circuit 40, pump 41 would likely need to be of more advanced design than pump 31 in first recycle circuit 30.

As mentioned above, the tail gas treatment system in the present figures comprises product stripper 50, purge gas scrubber 10, and optional tail gas reactor 20 that are appropriately interconnected to the rest of plant 1. The tail gas treatment system removes SO₂ from the small flow of purge gas before discharge to stack 11.

As shown in FIG. 1 and more detail in FIG. 2, product stripper 50 comprises stripping column 501, liquid inlet 502 for concentrated (i.e. >93%) sulfuric acid comprising dissolved sulfur dioxide from absorption apparatus 8 (shown as being 2000 ppm dissolved SO₂ for this example), stripping gas inlet 503 for an oxygen containing stripping gas (here pure oxygen supply 14), outlet 504 for sulfuric acid 52 partially stripped of sulfur dioxide (shown as being 20 ppm dissolved SO₂ for this example), and outlet 505 for stripping gas 51 comprising the sulfur dioxide partially stripped from the sulfuric acid. In product stripper 50, stripping column 501 is also used as the stripping column for the product acid from the plant.

Purge gas scrubber 10 comprises absorber column 101, inlet 102 for the sulfuric acid 52 partially stripped of sulfur dioxide from product stripper 50, purge gas inlet 103 for purge gas 400 obtained from gas outlet 8C of absorption apparatus 8, outlet 104 for sulfuric acid 54 comprising dissolved sulfur dioxide from purge gas 400 (shown as being 4500 ppm dissolved SO₂ for this example), and outlet 105 for purge gas 53 comprising purge gas partially stripped of sulfur dioxide (shown as being <1000 ppm SO₂ for this example).

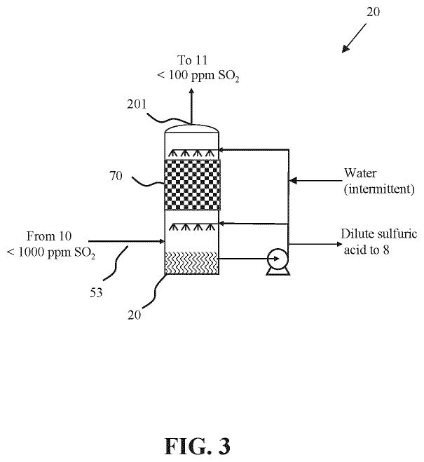

FIG. 3 is a schematic showing greater detail of tail gas reactor 20 in the tail gas treatment system of FIG. 1. Tail gas reactor 20 comprises reactor column 70 which comprises activated carbon and outlet 201 for tail gas discharged to the stack 11 (shown as being <100 ppm SO₂ for this example).

While the above description discloses the general arrangement and operation of certain embodiments of the invention, those of ordinary skill will appreciate that certain specifics may need to be modified somewhat in accordance with differing situations and plant apparatus. It is expected however that those of ordinary skill will readily be able to make such modifications based on the disclosed teachings for guidance.

The present invention addresses the situation that the residual gas stream in the plant, after the absorption apparatus, still contains a significant amount of sulfur dioxide which is preferably recycled to the contact apparatus for conversion to SO₃, and also contains inert gases that need to be purged to avoid a constant build-up in the “closed loop” system. The present approach represents a lower cost and more elegant way of taking the bulk of the residual SO₂ out of the purge stream notwithstanding that secondary tail gas treatment may still be required to obtain a vent gas low enough in SO₂ to be released to atmosphere.

The present invention adopts the novel approaches of using product acid as the wash or spray liquid provided to the purge gas scrubber and of using pure oxygen instead of air as the gas provided to the bottom of the product stripper. The product acid which is initially stripped of most of the dissolved sulfur dioxide therein is used to absorb sulfur dioxide in a purge gas scrubber thereby reducing the residual sulfur dioxide concentration in the purge gas stream to the 400-2000 ppm range. However, in some cases this concentration is still too high to be vented without further treatment. The sulfur dioxide laden acid in the purge gas scrubber is dealt with by directing the acid back to the absorption apparatus or product stripper to release the absorbed sulfur dioxide back into the main process stream. The product stripper in the present invention uses pure oxygen to strip dissolved sulfur dioxide out of the product acid (typically from about 2000 to about 20 ppm). The gas exiting the product stripper is then oxygen rich with sulfur dioxide therein and can be used as one of the oxygen sources in the combustion reactor of the plant.

As mentioned, the tail gas stream laden with 400-2000 ppm sulfur dioxide may need further treatment before it can be vented to atmosphere. The use of a tail gas reactor comprising activated carbon or other low temperature catalyst is an economical way to achieve low SO₂ emissions. The activated carbon or low temperature catalyst converts the SO₂ to SO₃ and/or H2SO₄ inside the pores of the material which is periodically removed as dilute (<20 wt %) sulfuric acid by rinsing the material with water. The dilute sulfuric acid can be added to the absorber tower as dilution liquid and hence no effluent is created.

The use of concentrated sulfuric acid is generally not considered for tail gas treatment because sulfur dioxide does not dissolve in sulfuric acid in large quantities. Further, the need to remove dissolved sulfur dioxide from product acid is not generally required in a conventional DCDA sulfur burning acid production plant since the acid is not in contact with gas streams with high sulfur dioxide concentrations and the acid is simply cooled before going to storage. In the present invention however, the gas flowing to the purge gas scrubber is both high concentration sulfur dioxide (e.g. >5 vol %) and a small volume flow. This results in enough sulfur dioxide being dissolved in the acid that the purge gas treatment system can operate with modest sulfuric acid flows. Using acid from the product stripper takes advantage of equipment already required in the process and reduces the cost of the plant. Further in theory, the system might be operated without any acid going to storage (i.e. the acid going to storage is not required for the functioning of the system).

The use of pure oxygen instead of air is also generally not considered because air is low cost and easy to add back into the conventional DCDA process.

The purge gas scrubber (and hence absorption apparatus) can be operated at a higher pressure than the product stripper. This can be advantageous as more SO₂ dissolves into the acid when operating at the elevated pressure and the required volume of acid required is reduced. Furthermore, the higher SO₂ partial pressure increases the speed at which the SO₂ is dissolved into the acid and thus reduces the height required of the tower. Finally, the higher pressure reduces the volume of purge gas and thus reduces the diameter of the purge gas scrubber required. This would generally not be considered in prior art plants because pressurizing the gas stream to the purge gas scrubber costs energy and the gas volumes that require treatment in typical sulfuric acid plant tail gas applications are very large and the energy required would be prohibitively expensive.

The compression of the purge gas can be advantageously carried out in a liquid ring compressor using either sulfuric acid or water as the seal liquid to create the liquid ring. This method has the advantage that the turbulent mixing of the liquid and gas inside the compressor already removes a portion of the SO₂ from the gas. In addition, it also accomplishes the compression at low temperature which improves removal of the SO₂ in the scrubber and prevents corrosion of the equipment. Excess seal liquid used in the compressor can simply be directed to the absorption column for recycle of the dissolved SO₂ and thus no effluent is created.

Cooling the sulfuric acid before entering the purge gas scrubber is known to be beneficial for absorption. In this application this can be done more economically as the acid delivered as product must be cooled to prevent corrosion in the storage tanks and no additional equipment needs to be installed.

While the present invention requires an extra purge gas scrubber, it is a more advantageous and economical way to remove high levels of SO₂ from the tail gas stream (that needs to be vented to control inert levels in the typical “closed loop” system) and return them to the process. Otherwise, a more substantial conventional tail gas treatment system would be required (e.g. a regenerative scrubber using amines or chemical scrubber using caustic, lime, etc.). To avoid these expensive amine-based systems or a chemical scrubber which would consume a substantial amount of energy or chemicals and produce an additional effluent, the present invention recovers most of the SO₂ in an efficient way and either no further tail gas treatment system would typically be required or the simplified tail gas reactor system of the present invention can be used.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A tail gas treatment system for a sulfuric acid production plant, the sulfuric acid production plant comprising a supply of pure oxygen, a combustion reactor for the combustion of sulfur to sulfur dioxide using oxygen from the supply of pure oxygen, a reactor gases heat exchanger fluidly connected to the combustion reactor for cooling combustion reactor outlet gases, a contact apparatus fluidly connected to the reactor gas heat exchanger for the conversion of sulfur dioxide to sulfur trioxide, an absorption apparatus fluidly connected to the contact apparatus for absorbing sulfur trioxide into sulfuric acid to form concentrated sulfuric acid, the tail gas treatment system, and an exhaust stack fluidly connected to the tail gas treatment system wherein the absorption apparatus comprises an outlet fluidly connected to both the combustion reactor and to the tail gas treatment system, characterized in that the tail gas treatment system comprises:
a product stripper comprising:
a stripping column;
a liquid inlet for concentrated sulfuric acid comprising dissolved sulfur dioxide from the absorption apparatus;
a stripping gas inlet for an oxygen containing stripping gas;
an outlet for sulfuric acid partially stripped of sulfur dioxide; and
an outlet for stripping gas comprising the sulfur dioxide partially stripped from the sulfuric acid;
and
a purge gas scrubber comprising:
an absorber column;
an inlet for the sulfuric acid partially stripped of sulfur dioxide from the product stripper;
a purge gas inlet for purge gas obtained from the gas outlet of the absorption apparatus;
an outlet for sulfuric acid comprising dissolved sulfur dioxide from the purge gas;
an outlet for purge gas comprising purge gas partially stripped of sulfur dioxide.

2. The tail gas treatment system of claim 1 wherein the oxygen containing stripper gas is pure oxygen from the supply of pure oxygen.

3. The tail gas treatment system of claim 1 comprising a heat exchanger for cooling the sulfuric acid partially stripped of sulfur dioxide from the product stripper.

4. The tail gas treatment system of claim 1 wherein the outlet for sulfuric acid from the purge gas scrubber is fluidly connected to a sulfuric acid inlet in the absorption apparatus.

5. The tail gas treatment system of claim 1 wherein the outlet for sulfuric acid from the purge gas scrubber is fluidly connected to the liquid inlet of the product stripper.

6. The tail gas treatment system of claim 1 wherein the outlet for stripping gas from the product stripper is fluidly connected to the combustion reactor or to the contact apparatus.

7. The tail gas treatment system of claim 1 comprising a liquid ring compressor for increasing the operating pressure of the purge gas scrubber.

8. The tail gas treatment system of claim 1 additionally comprising a tail gas reactor comprising activated carbon for removing sulfur dioxide from the purge gas obtained from the purge gas outlet of the purge gas scrubber.

9. A sulfuric acid production plant comprising:
a supply of pure oxygen;
a combustion reactor for the combustion of sulfur to sulfur dioxide using oxygen from the supply of pure oxygen;
a reactor gases heat exchanger fluidly connected to the combustion reactor for cooling combustion reactor outlet gases;
a contact apparatus fluidly connected to the reactor gas heat exchanger for the conversion of sulfur dioxide to sulfur trioxide;
an absorption apparatus fluidly connected to the contact apparatus for absorbing sulfur trioxide into sulfuric acid to form concentrated sulfuric acid;
the tail gas treatment system of claim 1; and
an exhaust stack fluidly connected to the tail gas treatment system,
wherein the absorption apparatus comprises an outlet fluidly connected to both the combustion reactor and to the tail gas treatment system

10. A method for removing sulfur dioxide from purge gas in a sulfuric acid production plant, the sulfuric acid production plant comprising a supply of pure oxygen, a reactor for the combustion of sulfur to sulfur dioxide using oxygen from the supply of pure oxygen, a reactor gases heat exchanger for cooling reactor outlet gases, a contact apparatus for the conversion of sulfur dioxide to sulfur trioxide, an absorption apparatus for absorbing sulfur trioxide into sulfuric acid to form concentrated sulfuric acid, a tail gas treatment system, and an exhaust stack wherein the tail gas treatment system is located between the absorption apparatus and the exhaust stack, the method comprising:
employing the tail gas treatment system of claim 1 as the tail gas treatment system in the plant;
obtaining purge gas from the gas outlet of the absorption apparatus; and
removing sulfur dioxide from the purge gas in the purge gas scrubber using sulfuric acid partially stripped of sulfur dioxide obtained from the product stripper;
wherein the sulfur dioxide concentration in the purge gas obtained from the gas outlet of the absorption apparatus is greater than at least 5% by volume.

11. The method of claim 10 wherein the sulfur dioxide concentration in the purge gas obtained from the gas outlet of the absorption apparatus is greater than or equal to 10% by volume.

12. The method of claim 10 wherein the operating pressure of the purge gas scrubber is greater than the operating pressure of the product stripper.
